(19) United States
(12) Patent Application Publication
(10) Pub. No.: US 2010/0228976 A1
(43) Pub. Date: Sep. 9, 2010

(54) METHOD AND APPARATUS FOR PROVIDING SECURED NETWORK ROBOT SERVICES

(75) Inventors: Hyung Kyu LEE, Daejeon (KR); Geon Woo KIM, Daejeon (KR); Seung-Hee OH, Daejeon (KR); Chol Soon JANG, Daejeon (KR); Jong-Wook HAN, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/619,150

(22) Filed: Nov. 16, 2009

(30) Foreign Application Priority Data
Mar. 5, 2009 (KR) 10-2009-0018845

(51) Int. Cl. H04L 9/08; H04L 9/32; H04L 9/00

(52) U.S. Cl. 713/168; 380/279; 380/44; 901/50

(57) ABSTRACT

At least one client robot in a domain are connected to a domain security management unit and a root security management unit is connected to at least one external server outside the domain and the domain security management unit via a network. A method for providing secured network robot services includes generating, at the domain security management unit, a shared key between the client robot and the external server when the client robot requests key distribution; generating, at the domain security management unit, a key distribution request message containing the shared key; and transmitting, at the domain security management unit, the key distribution request message to the external server.

### CROSS-REFERENCE(S) TO RELATED APPLICATION(S)

The present invention claims priority to Korean Patent Application No. 10-2009-0018845, filed on Mar. 5, 2009, which is incorporated herein by reference.

### FIELD OF THE INVENTION

The present invention relates to network robot services; and, more particularly, to a method and apparatus for providing secured network robot services, the method and apparatus being compatible with system architecture and key distribution for secured intelligent robot services.

### BACKGROUND OF THE INVENTION

Intelligent robot services provide users with useful and various content services, via communications between robot clients or between a robot client and a robot server connected via networks.

In order to provide various intelligent services, a robot serving as the subject of the services needs to have a variety of information and a processing power therefor. However, equipping a robot with a variety of information and a processing power therefor causes too much cost. Accordingly, a network robot, which is connected to various servers and downloads necessary information from the servers to provide services, is very effective solution.

However, conventional network robot services have a drawback in that security problems may occur as in other network environment. Further, since network robot environment is different from service environment without using network robots, various problems need to be solved before conventional security policy is applied to the network robot environment.

In general, the most critical problem in providing a secured service is key distribution for objects using the service. Examples of the key distribution are a public key method and a symmetric key method. The public key method is simple, but requires too much cost to implement high-performance key distribution. The symmetric key method is relatively free from restriction in performance, but has difficulty in distributing keys.

### SUMMARY OF THE INVENTION

In view of the above, the present invention provides security service technology for network robot services, in which a key distribution service in a domain and a cooperative service with external networks are managed separately to provide each subject of robot services with secured communications.

In accordance with an aspect of the present invention, there is provided a method for providing secured network robot services in a system having a domain security management unit and a root security management unit, wherein at least one client robot in a domain are connected to the domain security management unit and the root security management unit is connected to at least one external server outside the domain and the domain security management unit via a network, the method including:

generating, at the domain security management unit, a shared key between the client robot and the external server when the client robot requests key distribution;

generating, at the domain security management unit, a key distribution request message containing the shared key; and

transmitting, at the domain security management unit, the key distribution request message to the external server.

Preferably, the client robot requests the key distribution by transmitting a first key distribution request message to the domain security management unit.

Preferably, the first key distribution request message includes an identification of the client robot and an identification of the external server, and is protected by a shared key between the client robot and the domain security management unit.

Preferably, said transmitting the key distribution request message to the external server includes generating, at the domain security management unit, a second key distribution request message; transmitting, at the domain security management unit, the second key distribution request message to the root security management unit via the network; generating, at the root domain security management unit, a third key distribution request message; and transmitting, at the root domain security management unit, the third key distribution request message to the external server.

Preferably, the second key distribution request message includes an identification of the domain security management unit, an identification of the client robot, an identification of the external server and the shared key between the external server and the client robot, and is protected by a shared key between the domain security management unit and the root security management unit.

Preferably, the third key distribution request message includes an identification of the root security management unit, an identification of the client robot and the shared key between the external server and the client robot, and is protected by a shared key between the root security management unit and the root security management unit.

The method may further include receiving, at the root security management unit, from the external server a first response message in response to the key distribution request message; generating, at the root security management unit, a second response message in response to the first response message; transmitting, at the root security management unit, the second response message to the domain security management unit; generating, at the domain security management unit, a third response message in response to the second response message; and transmitting, at the domain security management unit, the third response message to the client robot.

Preferably, the first response message includes an identification of the external server, an identification of the client robot and a key distribution success message, and is protected by a shared key between the external server and the root security management unit.

Preferably, the second response message includes an identification of the root security management unit, an identification of the external server, an identification of the client robot and a key distribution success message, and is protected by a shared key between the domain security management unit and the root security management unit.

Preferably, the third response message includes an identification of the domain security management unit, an identification of the external server and the shared key between the external server and the client robot, and is protected by a shared key between the client robot and the domain security management unit.

Preferably, the shared key is used as an authentication key for use in secured communications between the external server and the client robot.

Preferably, the shared key between the client robot and the domain security management unit is a symmetric key based shared key.

In accordance with another aspect of the present invention, there is provided an apparatus for providing secured network robot services, including:

a domain security management unit to which at least one client robot in a domain is connected; and

a root security management unit connected to at least one external server outside the domain and the domain security management unit via a network,

wherein the domain security management unit and the root security management unit distributes a shared key for use in secured communications between the client robot and the external server.

Preferably, the client robot is a rich-client robot which shares a domain key with the domain security management unit.

The apparatus may further include a local server sharing a domain key with the domain security management unit.

Preferably, the client robot is a thin-client robot and connected to the local server.

Preferably, the root security management unit transmits a key distribution request message received from the domain security management unit to the external server and receives a key distribution success message transmitted by the external server in response to the key distribution request message, and the key distribution request message and the key distribution success message are transmitted while being protected by respective keys shared by a transmitter side and a receiver side of the messages.

Preferably, the external server is a content server providing the client robot with content for use in intelligent robot services.

Preferably, the external server is a remote robot control server remote-controlling the client robot.

Preferably, the shared key is a symmetric key.

According to the present invention, a domain security management unit and a root security management unit are adopted to solve security problems in network robot service environment and provide a security mechanism taking into consideration characteristics of network robot services. Specifically, an efficient key distribution mechanism can be constructed by considering characteristics of network robot services as well as by using symmetric key based key distribution. By maximizing security efficiency in a service domain and simplifying a key distribution procedure, restriction in robot services can be maximumly removed. Further, adoption of the root security management unit in external Internet environment guarantees seamless security services.

### BRIEF DESCRIPTION OF THE DRAWINGS

The above features of the present invention will become apparent from the following description of embodiments given in conjunction with the accompanying drawings, in which:

FIG. 1 illustrates a block diagram of an apparatus for providing secured network robot services in accordance with an embodiment of the present invention;

FIG. 2 illustrates an exemplary view of network robot services using the apparatus of FIG. 1;

FIG. 3 illustrates an exemplary view of a method for providing secured network robot services in accordance with an embodiment of the present invention, specifically, a procedure in which a domain security management unit transmits an authentication key and security policy to robots in a domain; and

FIG. 4 illustrates an exemplary view of the method for providing secured network robot services in accordance with the embodiment of the present invention, specifically, a key distribution procedure between a robot and an external server.

### DETAILED DESCRIPTION OF THE EMBODIMENTS

Hereinafter, embodiments of the present invention will be described in detail with reference to the accompanying drawings, which form a part hereof.

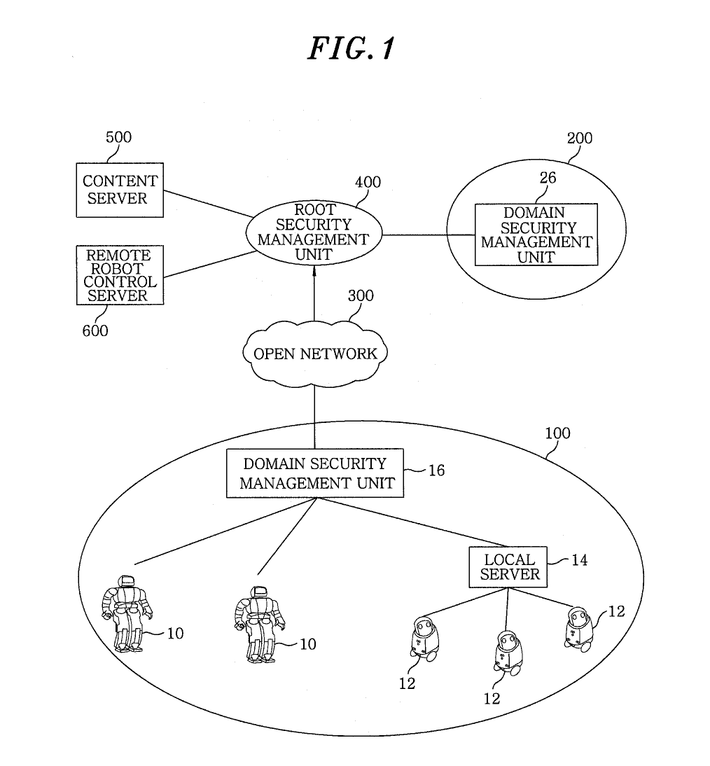

FIG. 1 illustrates a block diagram of an apparatus for providing secured network robot services in accordance with an embodiment of the present invention. The apparatus includes domains 100 and 200, an open network 300, a root security management unit 400, a content server 500 and a remote robot control server 600.

Referring to FIG. 1, an entire service architecture of the apparatus for providing secured network robot services is divided into an in-domain service environment in which client robots themselves provide services and an external network environment in which for using external services such as the Internet. The term “domain” in network robot environment refers a service domain, e.g., a home, an enterprise and a university.

Main entities for network robot security services in a domain, e.g., the domain 100, include rich-client robots 10, thin-client robots 12, a local server 14 and a domain security management unit 16.

The rich-client robots 10 are solely cooperative with external servers, e.g., the content server 500 and the remote robot control server 600. The rich-client robots 10 may be connected to the domain security management unit 16 and independently provide intelligent robot services in the domain 100. Though only two rich-client robots 10 are shown in FIG. 1 for convenience, it should be noted that three or more rich-client robots 10 can be connected to the domain security management unit 16.

The thin-client robots 12 which cannot provide independent services are managed by the local server 14. The thin-client robots 12 cooperate with external servers, e.g., the content server 500 and the remote robot control server 600, via the local server 14 to provide intelligent robot services. Though only three thin-client robots 12 are shown in FIG. 1 for convenience, it should be noted that four or more thin-client robots 12 can be connected to the domain security management unit 16 via the local server 14.

The domain security management unit 16 performs key distribution for the rich-client robots 10 and the thin-client robots 12 in the domain 100. To be specific, the domain security management unit 16 generates an authentication key assigned to the rich-client robots 10 and the thin-client robots 12 for use in secured communications therebetween, and distributes (transmits) the authentication key to the rich-client robots 10 and the thin-client robots 12 by using domain shared keys which will be described later.

Another domain for secured network robot services, e.g., the domain 200, also has the same configuration as that of the domain 100. That is, the domain 200 may include a domain security management unit 26 and a plurality of client robots.

Though only the domains 100 and 200 are described in this embodiment, it is obvious to those skilled in the art that domains other than the domains 100 and 200 can still be added.

The open network 300, e.g., the Internet, has architecture for supporting TCP/IP protocol and providing various upper layer services, e.g., HTTP (HyperText Transfer Protocol), Telnet, FTP (File Transfer Protocol), DNS (Domain Name System), SMTP (Simple Mail Transfer Protocol), SNMP (Simple Network Management Protocol), NFS (Network File Service) and NIS (Network Information Service). The open network 300 provides environment allowing a client robot, e.g., the rich-client robot 10, in the domain 100 to access the content server 500 and the remote robot control server 600 via the root security management unit 400. Meanwhile, main entities within external environment include the root security management unit 400, the content server 500 and the remote robot control server 600.

The root security management unit 400 provides the rich-client robots 10 and the thin-client robots 12 in the domain 100 with secured communications with the content server 500 and the remote robot control server 600. To be specific, the root security management unit 400 provides the rich-client robots 10 and the thin-client robots 12 in the domain 100 with shared keys with the domain security management unit 16, shared keys with the content server 500 and shared keys with the remote robot control server 600.

The content server 500 provides client robots in a domain, e.g., the domain 100, with content for use in intelligent robot services via the open network 300.

The remote robot control server 600 remote-controls client robots in a domain, e.g., the rich-client robots 10 in the domain 100, via the open network 300.

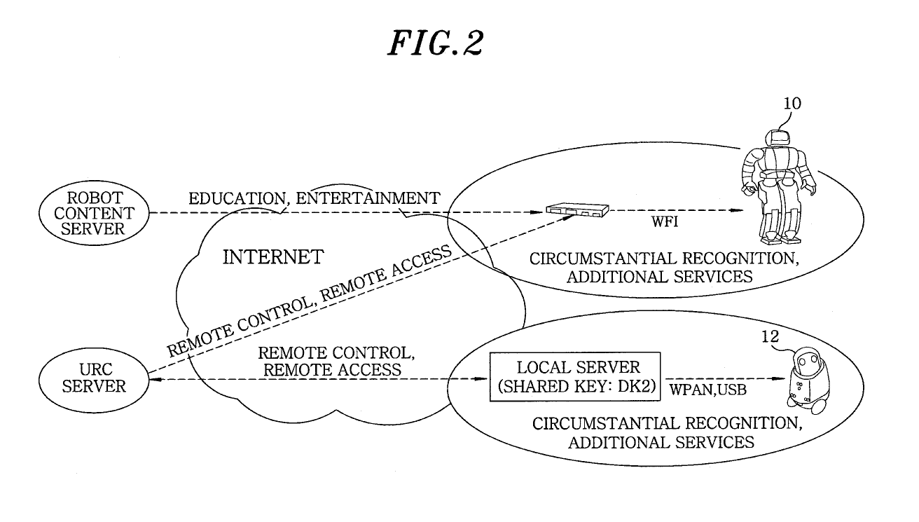

FIG. 2 illustrates an exemplary view of network robot services using the apparatus of FIG. 1.

As described above, robots are classified into the rich-client robots 10, which have high processing power and operating independently, and the thin-client robots 12, which have low processing power and cannot provide services independently.

Since the thin-client robots 12 cannot operate independently, the local server 14 is provided in order to provide intelligent robot services. Via the local server 14, the thin-client robots 12 cooperate with external servers, e.g., a robot content server and an URC (Ubiquitous Robotic Companion) server, in the Internet and provide various services.

Meanwhile, since the rich-client robots 10 can solely cooperate with the external servers, the rich-client robots 10 provide services without using the local server 14.

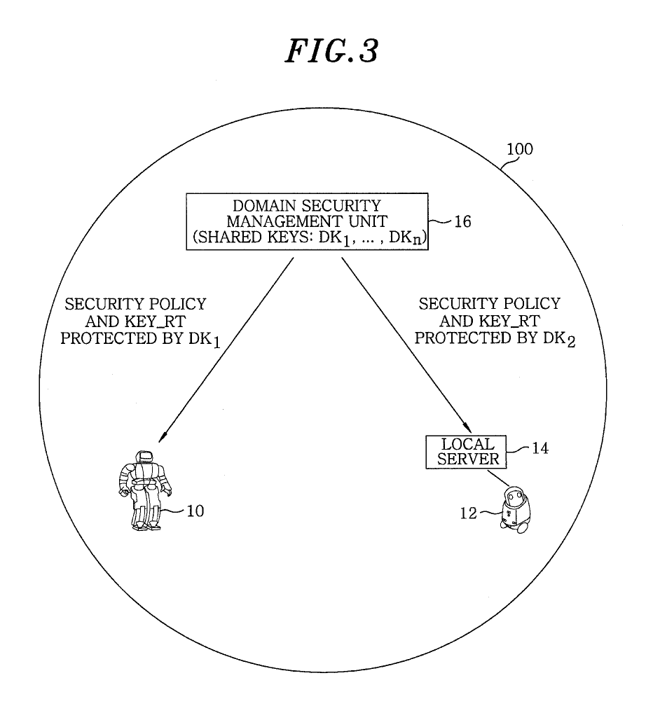

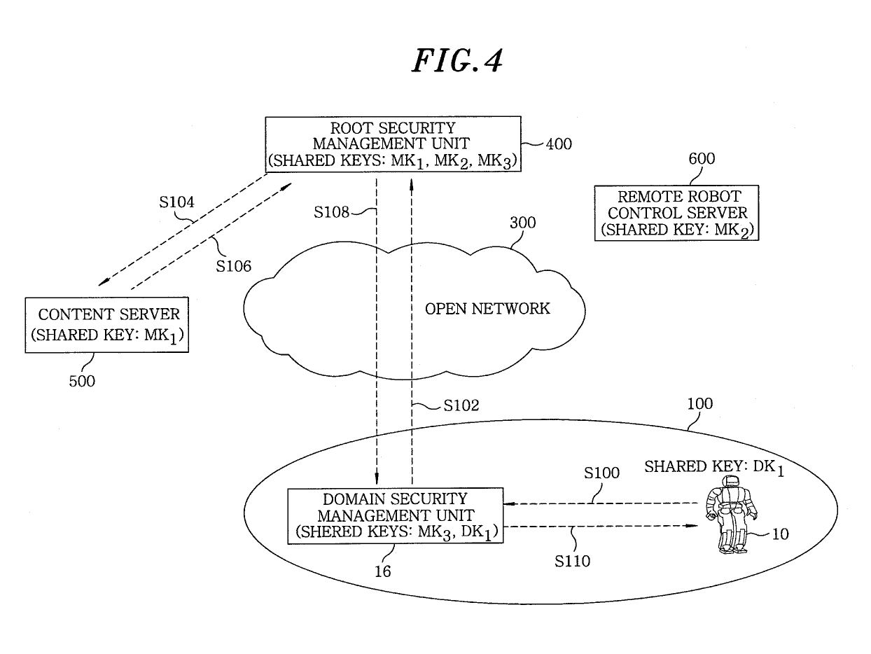

Below, a method for providing secured network robot services in accordance with an embodiment of the present invention will be described with reference to FIGS. 3 and 4.

FIG. 3 illustrates an exemplary view of a method for providing secured network robot services, specifically, a procedure in which the domain security management unit 16 transmits an authentication key and security policy to the robots 10 and 12 in the domain 100.

As shown in FIG. 3, the domain security management unit 16 transmits to the rich-client robot 10 and the thin-client robot 12 an authentication key KEY_RT for use in secured communications therebetween. At this time, if the authentication key KEY_RT is transmitted in a plain text form, the authentication key KEY_RT may be exposed to the outside. Thus, when transmitted, the authentication key KEY_RT is protected by using domain shared keys DK₁ to DKₙ. The domain shared key DKₙ is shared by the domain security management unit 16 of a domain and an n-th robot in the domain.

Referring to FIG. 3, the rich-client robot 10 shares the domain shared key DK₁ with the domain security management unit 16, while the thin-client robot 12 shares the domain shared key DK₂ with the domain security management unit 16, for example.

Therefore, the domain security management unit 16 may transmit the authentication key KEY_RT protected by the domain shared key DK₁ to the rich-client robot 10 by using a security protocol, while transmitting the authentication key KEY_RT protected by the domain shared key DK₂ to the thin-client robot 12.

As such, the domain security management unit 16 generates the authentication key KEY_RT for use in secured communications between the rich-client robot 10 and the thin-client robot 12 in the domain 100 managed the domain security management unit 16, and distributes the authentication key to the rich-client robot 10 and the thin-client robot 12 in the domain 100. As described above, the term “domain” in network robot environment refers a service domain, e.g., a home, an enterprise and a university. Since relatively small number of robots may work in the service domain, a symmetric key based security service can be provided.

The domain security management unit 16 may generate authentication keys for use in secured communications between robots in the domain 100 in advance. In such a case, if a robot is newly registered to the domain 100, the domain security management unit 16 shares a domain shared key with the newly registered robot and then distributes the authentication key generated in advance to the newly registered robot in the above-described manner.

Such unidirectional key distribution differs from key distribution by a key distribution server, e.g., Kerberos, and thus client robots do not need to access a separate key distribution server when the client robots carry out secured communications with each other.

For the thin-client robot 12, the local server 14 manages the authentication key for use in secured communications between the thin-client robot 12 and other client robot in the domain 100.

FIG. 4 illustrates an exemplary view of the method for providing secured network robot services, specifically, a key distribution procedure between the robot 10 in the domain 100 and the external content server 500.

In FIG. 4, the root security management unit 400, the content server 500, the remote robot control server 600 and the domain security management unit 16 in the domain 100 share shared keys MK₁, MK₂ and MK₃.

The shared keys MK₁, MK₂ and MK₃ are shared between the content server 500 and the root security management unit 400, between the remote robot control server 600 and the root security management unit 400, and between the domain security management unit 16 and the root security management unit 400, respectively.

As shown in FIG. 4, when the rich-client robot 10 in the domain 100 starts to communicate with an external entity, the client robot 10 transmits to the domain security management unit 16 a first key distribution request message to request key distribution for secured communication with the content server 500 (step S100). The first key distribution request message may include an ID (identification) of a sender, i.e., an ID of the client robot 10, and an ID of other party of the secured communications, i.e., an ID of the content server 500. The first key distribution request message may be protected by the domain shared key DK₁ between the rich-client robot 10 and the domain security management unit 16, as described above with respect to FIG. 3.

The domain security management unit 16 having received the first key distribution request message from the rich-client robot 10 generates a shared key AKEY to be shared between the content server 500 and the rich-client robot 10.

Thereafter, the domain security management unit 16 generates a second key distribution request message and transmits the second key distribution request message to the root security management unit 400 via the open network 300 (step S102). The second key distribution request message may include an ID of a sender, i.e., an ID of the domain security management unit 16, the ID of the rich-client robot 10, the ID of the content server 500 and the shared key AKEY shared between the content server 500 and the rich-client robot 10. The second key distribution request message may be safely transmitted to the root security management unit 400 while being protected by the shared key MK₃ shared between the root security management unit 400 and the domain security management unit 16.

The root security management unit 400 having received the second key distribution request message from the domain security management unit 16 generates a third key distribution request message to request distribution of the shared key AKEY to the content server 500, and transmits to the content server 500 the third key distribution request message protected by the shared key MK₁ between the content server 500 and the root security management unit 400 (step S104). The third key distribution request message may include an ID of a sender, i.e., an ID of the root security management unit 400, the ID of the rich-client robot 10 and the shared key AKEY between the content server 500 and the client robot 10.

The content server 500 obtains the shared key AKEY between the content server 500 and the rich-client robot 10 from the third key distribution request message received from the root security management unit 400, and registers the shared key AKEY as an authentication key with the rich-client robot 10. After that, the content server 500 generates a first response message and transmits the first response message to the root security management unit 400 (step S106). The first response message may include an ID of a sender, i.e., the ID of the content server 500, the ID of the rich-client robot 10 and a key distribution success message. The first response message may be transmitted to the root security management unit 400 while also being protected by the shared key MK₁ between the content server 500 and the root security management unit 400.

The root security management unit 400 having received the first response message generates a second response message, and transmits to the domain security management unit 16 the second response message protected by the shared key MK₃ between the domain security management unit 16 and the root security management unit 400 (step S108). The second response message may include an ID of a sender, i.e., the ID of the root security management unit 400, the ID of the content server 500, the ID of the rich-client robot 10 and the key distribution success message.

The domain security management unit 16 having received the second response message generates a third response message, and transmits to the rich-client robot 10 the third response message protected by the shared key DK₁ between the rich-client robot 10 and the domain security management unit (step S110). The third response message may include an ID of a sender, i.e., the ID of the domain security management unit 16, the ID of the content server 500 and the shared key AKEY between the content server 500 and the rich-client robot 10.

The rich-client robot 10 having received the third response message obtains the shared key AKEY between the content server 500 and the rich-client robot 10 from the third response message, and uses the shared key AKEY as an authentication key with the content server 500.

While the invention has been shown and described with respect to the embodiments, it will be understood by those skilled in the art that various changes and modification may be made without departing from the scope of the invention as defined in the following claims.

What is claimed is:

1. A method for providing secured network robot services in a system having a domain security management unit and a root security management unit, wherein at least one client robot in a domain are connected to the domain security management unit and the root security management unit is connected to at least one external server outside the domain and the domain security management unit via a network, the method comprising:
generating, at the domain security management unit, a shared key between the client robot and the external server when the client robot requests key distribution;
generating, at the domain security management unit, a key distribution request message containing the shared key; and
transmitting, at the domain security management unit, the key distribution request message to the external server.

2. The method of claim 1, wherein the client robot requests the key distribution by transmitting a first key distribution request message to the domain security management unit.

3. The method of claim 2, wherein the first key distribution request message includes an identification of the client robot and an identification of the external server, and is protected by a shared key between the client robot and the domain security management unit.

4. The method of claim 1, wherein said transmitting the key distribution request message to the external server includes:
generating, at the domain security management unit, a second key distribution request message;
transmitting, at the domain security management unit, the second key distribution request message to the root security management unit via the network;
generating, at the root domain security management unit, a third key distribution request message; and
transmitting, at the root domain security management unit, the third key distribution request message to the external server.

5. The method of claim 4, wherein the second key distribution request message includes an identification of the domain security management unit, an identification of the client robot, an identification of the external server and the shared key between the external server and the client robot, and is protected by a shared key between the domain security management unit and the root security management unit.

6. The method of claim 4, wherein the third key distribution request message includes an identification of the root security management unit, an identification of the client robot and the shared key between the external server and the client robot, and is protected by a shared key between the root security management unit and the root security management unit.

7. The method of claim 1, further comprising:
receiving, at the root security management unit, from the external server a first response message in response to the key distribution request message;
generating, at the root security management unit, a second response message in response to the first response message;
transmitting, at the root security management unit, the second response message to the domain security management unit;
generating, at the domain security management unit, a third response message in response to the second response message; and
transmitting, at the domain security management unit, the third response message to the client robot.

8. The method of claim 7, wherein the first response message includes an identification of the external server, an identification of the client robot and a key distribution success message, and is protected by a shared key between the external server and the root security management unit.

9. The method of claim 7, wherein the second response message includes an identification of the root security management unit, an identification of the external server, an identification of the client robot and a key distribution success message, and is protected by a shared key between the domain security management unit and the root security management unit.

10. The method of claim 7, wherein the third response message includes an identification of the domain security management unit, an identification of the external server and the shared key between the external server and the client robot, and is protected by a shared key between the client robot and the domain security management unit.

11. The method of claim 1, wherein the shared key is used as an authentication key for use in secured communications between the external server and the client robot.

12. The method of claim 3, wherein the shared key between the client robot and the domain security management unit is a symmetric key based shared key.

13. An apparatus for providing secured network robot services, comprising:
a domain security management unit to which at least one client robot in a domain is connected; and
a root security management unit connected to at least one external server outside the domain and the domain security management unit via a network,
wherein the domain security management unit and the root security management unit distributes a shared key for use in secured communications between the client robot and the external server.

14. The apparatus of claim 13, wherein the client robot is a rich-client robot which shares a domain key with the domain security management unit.

15. The apparatus of claim 13, further comprising:
a local server sharing a domain key with the domain security management unit.

16. The apparatus of claim 15, wherein the client robot is a thin-client robot and connected to the local server.

17. The apparatus of claim 13, wherein the root security management unit transmits a key distribution request message received from the domain security management unit to the external server and receives a key distribution success message transmitted by the external server in response to the key distribution request message, and wherein the key distribution request message and the key distribution success message are transmitted while being protected by respective keys shared by a transmitter side and a receiver side of the messages.

18. The apparatus of claim 17, wherein the external server is a content server providing the client robot with content for use in intelligent robot services.

19. The apparatus of claim 17, wherein the external server is a remote robot control server remote-controlling the client robot.

20. The apparatus of claim 13, wherein the shared key is a symmetric key.
